(19) United States
(12) Patent Application Publication
(10) Pub. No.: US 2008/0277322 A1
(43) Pub. Date: Nov. 13, 2008

(54) NOISE ABATING PERFORATED PLATE

(75) Inventor: Joseph L. Smith, Cincinnati, OH (US)

Correspondence Address: LEGAL DEPT., IP GROUP;M-I L.L.C., 5950 NORTH COURSE DRIVE, HOUSTON, TX, 77072, US

(73) Assignee: M-I L.L.C., Houston, TX (US)

(21) Appl. No.: 12/106,818

(22) Filed: Apr. 21, 2008

Related U.S. Application Data
(60) Provisional application No. 60/917,350, filed on May 11, 2007.

(51) Int. Cl. B07B 1/46

(52) U.S. Cl. 209/363

(57) ABSTRACT

Disclosed herein is a perforated plate and a screening assembly for separating particulate matter comprising perforated plate, the perforated plate comprising a plurality of apertures of a selected size for receiving and separating the particulate matter, wherein the plate comprises a laminate, the laminate comprising two metal layers spaced apart by and joined by a damper layer comprising a viscoelastomer. A method of reducing noise generated by a vibratory separating apparatus using the inventive perforated plate is also disclosed.

### CROSS-REFERENCE TO RELATED APPLICATIONS

This application claims priority to U.S. Provisional Patent Application No. 60/917,350, filed May 11, 2007, the disclosure of which is incorporated herein by reference.

### BACKGROUND OF INVENTION

1. Field of the Invention

The instant disclosure generally relates to apparatus and method for a noise abating perforated plate. More precisely, a noise abating perforated plate for use in a vibratory shaker or screening separator apparatus.

2. Background Art

Vibratory screen separators are well known. Tensioned metal screen cloth and/or perforated plates are normally used in such devices. Such separators typically employ either rectangular or circular screens which are driven by rotating eccentric weights or other vibration inducing mechanisms. The vibration assists in the passage of material through the perforations in the screens and/or plates wherein the material is separated based on the size of materials. However, blinding of the screens remains a frequent problem. To substantially prolong the effectiveness of a screen by reducing blinding, self-cleaning systems have been developed. In circular vibratory screening devices, screen assemblies have included self-cleaning systems having a flow-through support surface spanning across the screen frame and located below and substantially parallel to the screen cloth. Such flow-through support surfaces have been defined by perforated metal plates, screens and the like. Normally the support includes openings which are larger than the openings in the overlaying screen cloth. However, other arrangements may be employed in specific circumstances. So called “sliders” are positioned in the space between the support surface and the screen cloth. These sliders are frequently cylindrical in cross section. They are induced by the vibration of the screening mechanism to move about such a circular screening device and impact against the screen cloth under the influence of the vibratory motion of the separator. This repeated impact of the sliders acts to free the screen cloth of material such that it eventually will pass through the screen or be separated off. However, the action of the sliders against the perforated plate results in generation of a considerable amount of noise on the order of 100 dB or more. Noise abatement systems for vibratory screening devices typically include locating the device in a noise abatement enclosure designed to absorb the sound generated by the device. Noise abatement materials may also be placed in physical communication with the device to attenuate the noise produced.

Other references directed to noise abatement systems for vibratory screening devices include U.S. Pat. No. 7,025,210 to Mooney. generally directed to a method of attenuating the sound emanating from a bank of a plurality of vibrating screens of a plurality of vibrating screening machines including the steps of providing a master pulse of known phase and frequency, comparing the phase and frequency of a plurality of vibrating screens with the known phase and frequency of said master pulse, and adjusting the phase and frequency of said bank of plurality of vibrating screens so that the waveforms produced thereby tend to cancel each other.

In addition, U.S. Pat. No. 4,180,458 to Shahan is generally directed towards a relatively quiet vibrating screen has a rotatable eccentric mass drive supported on the screen body by isolator mounts which transmit vibratory forces at shaker frequency unrestrained to the screen body and attenuate forces at higher harmonics of shaker frequency that would otherwise excite wall panels of the screen body into resonance, thereby reducing the noise level of the screen.

While numerous referenced are directed to self cleaning systems for vibratory screens and abating the noise generated by such devices, lessening the generation and/or production of the noise produced by the device has been largely ignored.

As can be seen, there is a need for devices and methods of operation in which the amount of noise produced by a vibratory screening device is decreased relative to vibratory screening devices known in the art.

### SUMMARY OF INVENTION

In one aspect of the present invention, a perforated plate for a screen assembly comprises a laminate, the laminate comprising two metal layers spaced apart by and joined by a damper layer comprising a viscoelastomer.

In another aspect of the present invention, a screening assembly for separating particulate mailer comprises a perforated plate, the plate comprising a plurality of apertures of a selected size for receiving and separating the particulate matter, wherein the plate comprises a laminate, the laminate comprising two metal layers spaced apart by and joined by a damper layer comprising a viscoelastomer.

In still another aspect of the present invention a method of reducing noise in a vibratory separating apparatus comprising a screening assembly for separating particulate matter comprising a perforated plate, the method comprises the steps of operating a vibratory separating apparatus comprising a perforated plate comprising a laminate, the laminate comprising two metal layers spaced apart by and joined by a damper layer comprising a viscoelastomer.

These and other features, aspects and advantages of the present invention will become better understood with reference to the following drawings, description and claims.

### BRIEF DESCRIPTION OF THE DRAWINGS

FIG. 1 is a partial cross-sectional view of a self cleaning kit for use in a vibratory screening apparatus;

FIG. 2 is a perspective view of a self cleaning kit for use in a vibratory screening apparatus; and

FIG. 3 is a cross-sectional view of an embodiment of a perforated plate for a screen assembly of the instant disclosure;

FIG. 4 is a cross-sectional view of another embodiment of a perforated plate for a screen assembly of the instant disclosure; and

FIG. 5 is a graphical representation of noise data of the instant disclosure.

### DETAILED DESCRIPTION

The following detailed description is of the best currently contemplated modes of carrying out the invention. The description is not to be taken in a limiting sense, but is made merely for the purpose of illustrating the general principles of the invention, since the scope of the invention is best defined by the appended claims.

Broadly, the present invention generally provides a perforated plate for a screening assembly, and/or a screening assembly for separating particulate matter comprising, a perforated plate, the plate comprising a plurality of apertures of a selected size for receiving and separating the particulate matter, wherein the plate comprises a laminate, the laminate comprising two metal layers spaced apart by and joined by a damper layer comprising a viscoelastomer.

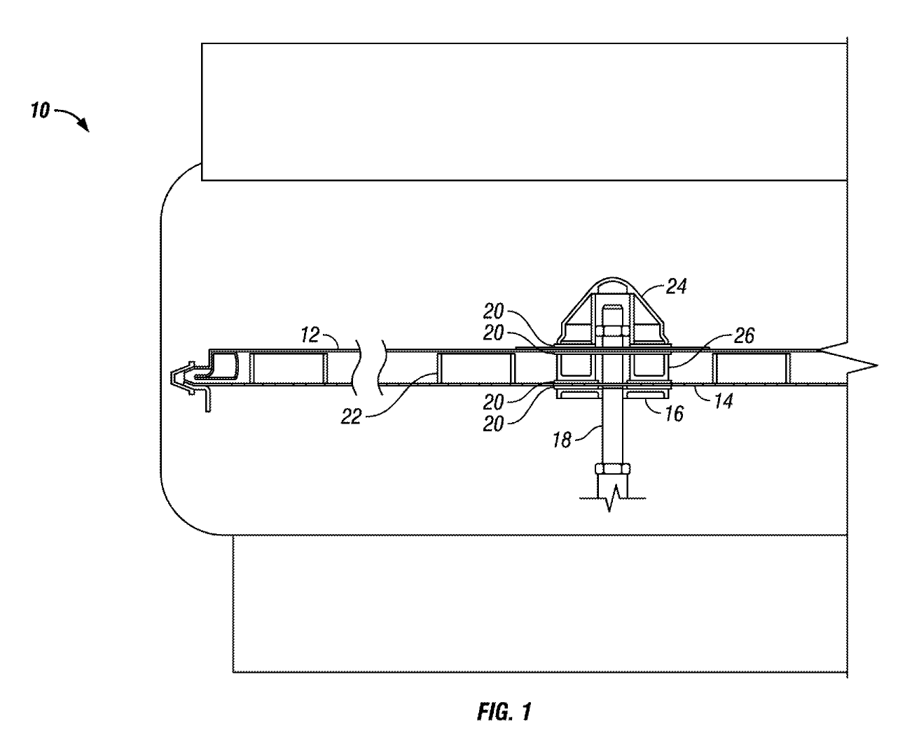

As shown in FIG. 1, in an embodiment of the instant disclosure, a vibratory screening apparatus, generally referred to as 10 comprises a support surface 14 in the form of a perforated plate for a screening assembly, employed below a screen or other size exclusion element 12. In an embodiment, a plurality of cleaning elements 22 is disposed between screen 12 and perforated plate 14. In the embodiment shown, both screen 12 and perforated plate 14 are attached to a center shaft 18 employing attaching means 24, a center support member 16, a plurality of gaskets 20, and spacers 26, as are typical in the art.

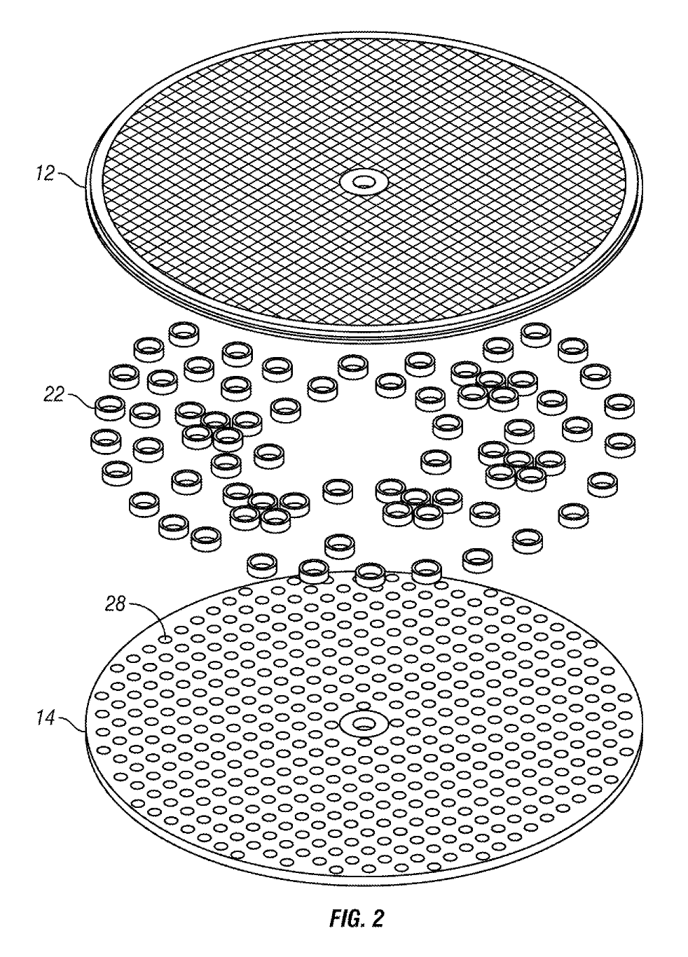

As shown in FIG. 2, perforated plate 14 may have a plurality of apertures 28 of a selected size for receiving and separating the particulate matter (not shown). Suitable cleaning elements 22 include sliders and/or balls.

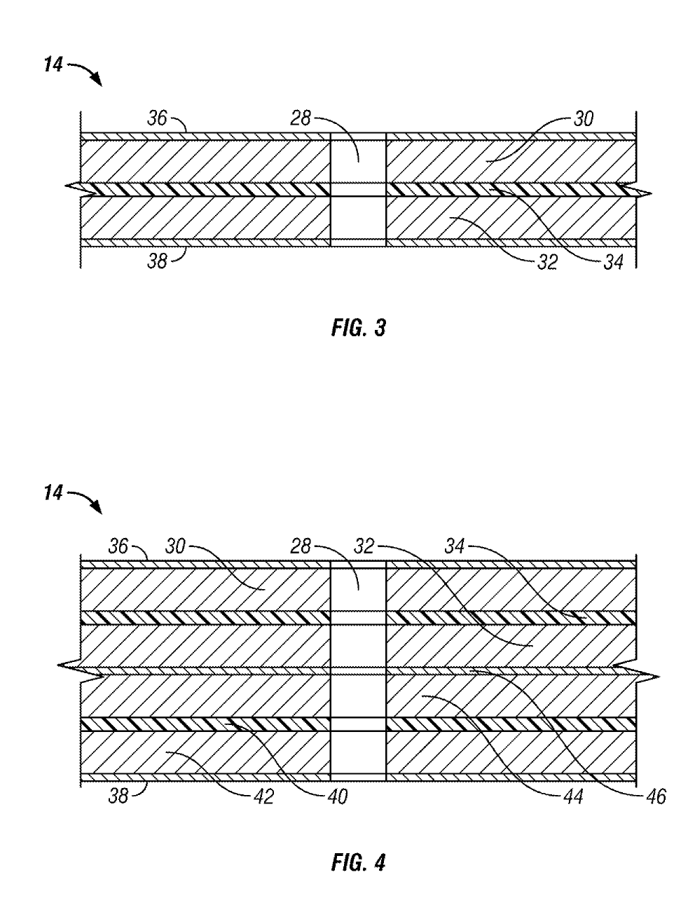

As shown in FIG. 3, perforated plate 14 comprises a laminate comprising two metal layers 30 and 32 spaced apart by and joined by a damper layer 34 comprising a viscoelastomer. In an embodiment, perforated plate 14 comprises a laminated sheet structure. This laminated sheet structure and methods of producing the same are described in U.S. Pat. Nos. 7,172,800, 7,094,478, 7,040,691, 6,974,634, 6,621,658, 6,465,110, 6,202,462, and 5,851,342, all of which are incorporated by reference herein for teachings directed to the instant laminated sheet structure. This laminated sheet structure is available under the product name Quiet Steel® from Material Sciences Corporation of Farmington Mills, Mich. In an embodiment, the laminated sheet structure includes first and second cold rolled sheets of steel 30 and 32 having a damping layer comprising an engineered viscoelastic layer 34 there-between spanning the entirety of both steel sheets 30 and 32. Perforated plate 14 may further include one or more coating layers 36 and 38 provided on both of the cold rolled steel sheets 30 and 32 which may provide corrosion resistance, chemical resistance, dry lubrication, and the like.

The metal layers 30 and 32 may be formed of any suitable metal, such as steel, aluminum or the like, and may be formed of the same material, or each of different materials. Damping layer 34 comprises a viscoelastic layer which is a plastic viscoelastic material designed to optimally damp vibration in a desired temperature range, depending on the application in which the vibratory screening apparatus is being used. Preferably, the damping layer 34 comprises a viscoelastic material, which serves both noise-damping and adhesive attachment functions.

As shown in FIG. 4, perforated plate 14 may further comprise a plurality of metal layers 30, 32, 42, and 44, each interposed between a plurality of viscoelastic layers 34, 40, and 46. The thickness of the metal layers may be the same or may differ from one another. Similarly, the various viscoelastic layers may have equal thickness or may each have a thickness different from the other. The thickness of each layer may be determined and adjusted based on the intended application of the damper component, as well as other factors, including, for example, the materials selected for the metal layers and the viscoelastic layers. By way of example and not necessarily limitation, the viscoelastic layer of an embodiment has a thickness of about 1 to about 5000 micrometers. Each of the metal layers may have a thickness of about 50 to 10,000 micrometers.

According to embodiments of the invention, the viscoelastic 1 may comprise, consist essentially of, or consist of one or more viscoelastomers. A viscoelastomer is stress-strain responsive. At a given temperature, the stress-strain response of a viscoelastomer is dependent upon the strain rate. At high strain rates, a viscoelastomer will exhibit more elastic behavior, while at low strain rates a viscoelastomer will exhibit more viscous behavior. A viscous behavior is generally defined as the ability of the material to significantly deform under load and to convert the energy stored by deformation into heat. An elastic behavior is the ability to exhibit a reversible deformation under load. The viscoelastic layer preferably comprises, and more preferably consists essentially of at least one member selected from the group consisting of a (meth)acrylic acid based polymer and a (meth)acrylate-based polymer. As referred to herein as generally used in the art; the term (meth)acrylic means acrylic and/or methacrylic. Similarly, the term (meth)acrylate means acrylate and/or methacrylate. By way of example and not necessarily limitation, suitable (meth)acrylate-based polymers include acrylic acid ester homopolymers. The (meth)acrylate-based polymer may also comprise copolymers or terpolymers of a plurality of different (meth)acrylic acid esters or a combination of a (meth)acrylic acid ester and one or more copolymerizable monomer, oligomers, or prepolymers. In the case of copolymers and terpolymers, the (meth)acrylate-based polymer fraction may constitute a majority (more than 50 weight percent) of the total weight of polymer(s) in the viscoelastic material. According to another embodiment of the present invention, the viscoelastic layer may comprise a rubber, such as nitrite rubbers (e.g., acrylonitrile, acetonitrile), silicone rubber, fluoroelastomers, other elastomers, and combinations thereof. A currently preferred viscoelastic material is 5-mil tape of Avery Dennison™ HUE 1185, an acrylic adhesive available from AveryDennison.

The choice of viscoelastic material may optionally take into consideration the likely operating temperature to which the perforated plate will be subject during use. The viscoelastic material preferably has a glass transition temperature (Tg) at or below the operating temperature of the vibratory screening device. The viscoelastic material preferably has high damping properties near the intended operating temperature. Selection of the viscoelastic material may take into account the loss factor of the metal layers and the viscoelastomer, and the desired loss factor to be achieved. Loss factor is generally understood in the art as the ratio of dissipated energy (or energy loss) per radian divided by the peak potential or strain energy of a specimen. In an embodiment of the instant disclosure, loss factor (measured by ASTM E 756 98) of the viscoelastic material is greater than 0.5, and in another embodiment greater than 1.0, at the targeted temperatures. The viscoelastic layer may optionally contain fillers, such as carbon nanotubes, chopped fibers (e.g., glass, carbon, aramid), inorganic particles (e.g., silica), fly ash, and the like. According to an embodiment of the invention, however, the viscoelastic layer optionally may be substantially free of fillers, especially inorganic fillers such as silica.

In an embodiment, a method of reducing noise in a vibratory separating apparatus comprising a screening assembly for separating particulate matter comprising the instant perforated plate, comprises the steps of operating a vibratory separating apparatus comprising a perforated plate comprising a laminate, the laminate comprising two metal layers spaced apart by and joined by a damper layer comprising a viscoelastomer.

In another embodiment, the noise generated by operation of the screening assembly in a vibratory separating apparatus is less than the noise generated by operation of a comparative screening assembly comprising a comparative perforated plate in an essentially identical comparative vibratory separating apparatus operated under essentially identical conditions, wherein the comparative perforated plate is fabricated from a solid metal plate. Preferably, the noise generated by operation of the essentially identical comparative screening assembly is at least 5 dBA less, preferably 10 dBA less, more preferably 15 dBA less, more preferably 20 dBA less than the noise generated by the essentially identical comparative vibratory separating apparatus operated under essentially identical conditions.

### EXAMPLES

A vibratory screening apparatus was set-up using a plurality of sliders positioned between a perforated plate and a screen. The apparatus was run empty, both with and without a cover, and the noise level was recorded in decibels (dBA) using a calibrated sound level and frequency analyzer (Quest Technologies, Model SE/DL.) In particular, an 80 Mesh screen with 6 inch center tiedown using a quick change center tiedown configuration on a 48″ Round Separator Single Deck@1200 RPM and top and bottom weight setting of: 14 and 8-45-8 (Sweco round separators, 48 inch, Models XS and GB.) Various sliders were evaluated. A comparative set-up utilized a perforated plate typical in the art. The comparative perforated plate consisted of a single layer of 16 gauge 304 stainless steel. Exemplary evaluations were run under identical conditions using a perforated plate comprising a laminate as described herein. The inventive perforated plate comprised a 304 stainless steel top layer (0.0299″) and an identical bottom layer, with a total thickness of 0.058″ (16 gauge.) Accordingly, the damper layer comprising a viscoelastomer was less than about 0.001″ thick. The inventive perforated plate was fabricated from a laminate commercially available under the trade name Quiet Steel®, (Material Sciences, Elk Grove Village, III.)

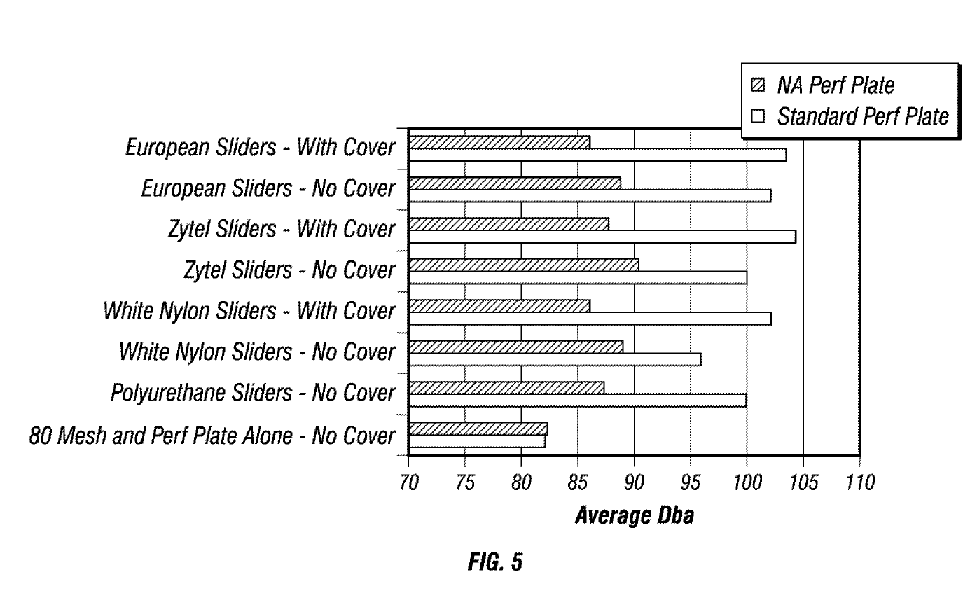

The data is in Tables 1 and 2 and shown graphically in FIG. 5.

TABLE 1
Inventive Laminated Metal Perf Plate Sound Data

| | Run | Run | Run | Run | Run | Run | |
|---|---|---|---|---|---|---|---|
| | #1 | #2 | #3 | #4 | #5 | #6 | Average |
| | (dBA) | (dBA) | (dBA) | (dBA) | (dBA) | (dBA) | (dBA) |
| 80 Mesh and Perf Plate Alone - No Cover | 81.1 | 82.1 | 82.6 | 82.6 | 81.5 | 83.4 | 82.2 |
| 80 Mesh and Perf Plate Alone - With Cover | 80.1 | 80.4 | 81.0 | 81.1 | 80.2 | 80.5 | 80.6 |
| Polyurethane Sliders - No Cover | 86.8 | 87.0 | 87.9 | 88.0 | 87.0 | 87.3 | 87.3 |
| Polyurethane Sliders - With Cover | 84.6 | 85.2 | 85.6 | 84.0 | 83.7 | 85.8 | 84.8 |
| White Nylon Sliders - No Cover | 88.5 | 89.3 | 89.3 | 89.0 | 88.3 | 89.5 | 89.0 |
| White Nylon Sliders - With Cover | 86.0 | 86.5 | 86.7 | 85.1 | 85.3 | 87.0 | 86.1 |
| Zytel Sliders - No Cover | 89.6 | 90.7 | 91.0 | 90.7 | 90.3 | 90.7 | 90.5 |
| Zytel Sliders - With Cover | 87.1 | 87.6 | 88.3 | 89.1 | 87.4 | 87.2 | 87.8 |
| Clear Sliders - No Cover | 88.1 | 88.9 | 88.8 | 89.5 | 88.8 | 88.6 | 88.8 |
| Clear Sliders - With Cover | 85.6 | 85.6 | 85.9 | 87.4 | 85.9 | 86 | 86.1 |

TABLE 2
Comparative Metal Perf Plate Sound Data

| | Run | Run | Run | Run | Run | Run | |
|---|---|---|---|---|---|---|---|
| | #1 | #2 | #3 | #4 | #5 | #6 | Average |
| | (dBA) | (dBA) | (dBA) | (dBA) | (dBA) | (dBA) | (dBA) |
| 80 Mesh and Perf Plate Alone - No Cover | 81.6 | 81.8 | 82.9 | 82.8 | 82.2 | 81.6 | 82.2 |
| 80 Mesh and Perf Plate Alone - With Cover | 80.2 | 80.3 | 80.6 | 81.3 | 80.3 | 80.1 | 80.5 |
| Polyurethane Sliders - No Cover | 99.2 | 99.8 | 99.7 | 100.4 | 99.9 | 99.9 | 99.8 |
| Polyurethane Sliders - With Cover | 97.6 | 96.8 | 96.7 | 98.4 | 96.4 | 97.4 | 97.2 |
| White Nylon Sliders - No Cover | 101.6 | 102.0 | 101.7 | 102.6 | 102.3 | 102.1 | 102.1 |
| White Nylon Sliders - With Cover | 99.9 | 99.8 | 99.8 | 101.3 | 99.4 | 99.9 | 100.0 |
| Zytel Sliders - No Cover | 103.9 | 104.1 | 104.3 | 104.5 | 104.0 | 104.2 | 104.2 |
| Zytel Sliders - With Cover | 102.1 | 101.3 | 101.5 | 103.6 | 102.0 | 102.0 | 102.1 |
| Clear Sliders - No Cover | 103.2 | 103.4 | 103.7 | 103.9 | 103.3 | 103.6 | 103.5 |
| Clear Sliders - With Cover | 100.1 | 100.8 | 100.9 | 100.9 | 101.7 | 101.1 | 100.9 |

Accordingly, the inventive perforated plate reduces sound levels 9-14 dBA from standard 304 SS material. Based on sound readings, peak dBA's were observed in frequency ranges of 1-5 kHz. Empirical data (from tests) further indicate that material can withstand up to 5 g's during operation, which suggests the material properties of the laminate are not degraded over time.

It should be understood, of course, that the foregoing relates to preferred embodiments of the invention and that modifications may be made without departing from the spirit and scope of the invention as set forth in the following claims.

What is claimed:

1. A perforated plate for a screen assembly, the plate comprising a laminate, the laminate comprising two metal layers spaced apart by and joined by a damper layer comprising a viscoelastomer.

2. The perforated plate of claim 1, wherein each of the metal layers has a thickness greater than the thickness of the viscoelastic layer.

3. The perforated plate of claim 1, wherein each of the metal layers are comprised of cold rolled steel.

4. The perforated plate of claim 1, wherein the damper layer comprises a polymeric reaction product of a composition comprising (meth)acrylic acid, (meth)acrylate, polyacrylate, nitrile rubber, fluoroelastomers, or a combination thereof.

5. The perforated plate of claim 1, wherein the damper layer is free of fillers.

6. The perforated plate of claim 1, wherein the damper layer comprises high density filler comprising glass, carbon, aramids, metal, plastics, alumina, silica, silicon, ceramic, graphite, chopped fiberglass, or a combination thereof.

7. The perforated plate of claim 1, wherein the damper layer has a thickness of about 1 to about 500 micrometers.

8. The perforated plate of claim 1, wherein the noise generated by operation of the screening assembly in a vibratory separating apparatus is less than the noise generated by operation of a comparative screening assembly comprising a comparative perforated plate in an essentially identical vibratory separating apparatus operated under essentially identical conditions, wherein the comparative perforated plate is fabricated from a solid metal plate.

9. A screening assembly For separating particulate matter comprising, a perforated plate, the plate comprising a plurality of apertures of a selected size for receiving and separating the particulate matter, wherein the perforated plate comprises a laminate, the laminate comprising two metal layers spaced apart by and joined by a damper layer comprising a viscoelastomer.

10. A method of reducing noise in a vibratory separating apparatus comprising a screening assembly for separating particulate matter comprising a perforated plate, the steps comprising operating a vibratory separating apparatus comprising a perforated plate comprising a laminate, the laminate comprising two metal layers spaced apart by and joined by a damper layer comprising a viscoelastomer.

11. The method of claim 10, wherein each of the metal layers has a thickness greater than the thickness of the viscoelastic layer.

12. The method of claim 10, wherein each of the metal layers are comprised of cold rolled steel.

13. The method of claim 10, wherein the damper layer comprises a polymeric reaction product of a composition comprising (meth)acrylic acid, (meth)acrylate, polyacrylate, nitrile rubber, fluoroelastomers, or a combination thereof.

14. The method of claim 10, wherein the damper layer is free of fillers.

15. The method of claim 10, wherein the damper layer comprises high density filler comprising glass, carbon, aramids, metal, plastics, alumina, silica, silicon, ceramic, graphite, or a combination thereof.

16. The method of claim 10, wherein the damper layer comprises chopped fiberglass.

17. The method of claim 10, wherein the damper layer has a thickness of about 1 to about 500 micrometers.

18. The method of claim 10, wherein the noise generated by operation of the screening assembly in a vibratory separating apparatus is less than the noise generated by operation of a comparative screening assembly comprising a comparative perforated plate in an essentially identical comparative vibratory separating apparatus operated under essentially identical conditions, wherein the comparative perforated plate is fabricated from a solid metal plate.

19. The method of claim 18, wherein the noise generated by operation of the essentially identical comparative screening assembly is at least 10 dBA less than the noise generated by the essentially identical comparative vibratory separating apparatus operated under essentially identical conditions.

20. The method of claim 18, wherein the noise generated by operation of the essentially identical comparative screening assembly is at least 20 dBA less than the noise generated by the essentially identical comparative vibratory separating apparatus operated under essentially identical conditions.
